(19) United States
(12) Patent Application Publication
(10) Pub. No.: US 2013/0182165 A1
(43) Pub. Date: Jul. 18, 2013

(54) IMAGE SENSOR, IMAGING APPARATUS, ELECTRONIC DEVICE, AND IMAGING METHOD

(71) Applicant: SONY CORPORATION, Tokyo (JP)

(72) Inventor: Yasutaka Kimura, Kanagawa (JP)

(73) Assignee: SONY CORPORATION, Tokyo (JP)

(21) Appl. No.: 13/722,403

(22) Filed: Dec. 20, 2012

(30) Foreign Application Priority Data
Jan. 12, 2012 (JP) 2012-003998

(51) Int. Cl. H04N 5/335

(52) U.S. Cl. CPC H04N 5/335
USPC 348/311

(57) ABSTRACT

There is provided an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal.

### BACKGROUND

The present technology relates to an image sensor. More particularly, the present technology relates to an image sensor that performs pixel addition on a plurality of pixels, an imaging apparatus and an electronic device having the image sensor, and an imaging method for use in the image sensor, the imaging apparatus and the electronic device.

Recently, an electronic device (for example, an imaging apparatus such as a digital still camera) that generates an image (image data) by imaging an object such as a human and records the generated image (image data) as image content (an image file) has become widespread. As an image sensor for use in the electronic device, a charge coupled device (CCD) sensor, a complementary metal oxide semiconductor (CMOS) sensor, and the like have become widespread.

For example, an image sensor having a plurality of types of pixels has been proposed (for example, see Japanese Patent Application Publication No. 2010-62785).

### SUMMARY

A high dynamic range (HDR) image of which camera blur has been appropriately corrected can be generated in the above-described related art.

As described above, in the above-described related art, the appropriately corrected image can be generated. Here, predetermined image processing is performed on an image signal output from the image sensor. For example, because the image sensor is formed by the plurality of types of pixels (for example, green (G), red (R), and blue (B) pixels), a special calculation process for correcting positions of the pixels is performed on image signals output from the pixels. As described above, because it is necessary to perform various image processing on the image signals output from the image sensor, it is important to reduce a load imposed on the image processing.

It is desirable to reduce a load imposed on image processing.

The present technology is provided to solve the above-mentioned issues. According to a first embodiment of the present technology, there is provided an image sensor and an imaging method thereof in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal. Thereby, there is an effect that the analog addition is performed on the image signals from the pixels for each pair of pixels of spectral sensitivity constituting each pixel group, and the analog addition result is designated as the output signal.

Further, according to the first embodiment of the present technology, by designating as a first line a line formed by pixels for generating a long-time-exposure image according to continuous exposure within a predetermined period among lines formed by the first pixel group and the second pixel group in a specific direction, and designating as a second line a line formed by pixels for generating a plurality of short-time-exposure images according to intermittent exposure within the predetermined period among the lines formed by the first pixel group and the second pixel group in the specific direction, the first line and the second line may be alternately arranged in an orthogonal direction orthogonal to the specific direction.

Thereby, there is an effect that the analog addition is performed on the image signals from the pixels in which the first line and the second line are alternately arranged in the orthogonal direction orthogonal to the specific direction, and the analog addition result is designated as the output signal.

Further, according to the first embodiment of the present technology, the first pixel group and the second pixel group are pixel groups of a matrix shape in which two pixels are arranged in a specific direction and two pixels may be arranged in an orthogonal direction orthogonal to the specific direction. Thereby, there is an effect that the analog addition is performed on the image signals from the pixels constituting the pixel groups of the matrix shape in which the two pixels are arranged in the specific direction and the two pixels are arranged in the orthogonal direction and the analog addition result is designated as the output signal.

Further, according to the first embodiment of the present technology, a position in the first pixel group of the one pair of pixels of the first spectral sensitivity constituting the first pixel group may be identical to a position in the second pixel group of the one pair of pixels of the first spectral sensitivity constituting the second pixel group. Thereby, there is an effect that the analog addition is performed on the image signals from the pixels constituting the pixel group having the same position as the pixel group of one pair of pixels of the first spectral sensitivity and the analog addition result is designated as the output signal.

Further, according to the first embodiment of the present technology, by designating a line formed by pixels of the first spectral sensitivity in a diagonal direction as a first line, designating a line formed by pixels of the second spectral sensitivity in the diagonal direction as a second line, and designating a line formed by pixels of the third spectral sensitivity in the diagonal direction as a third line, the first line may be arranged alternately with the second and third lines in an orthogonal direction orthogonal to the diagonal direction. Thereby, there is an effect that the analog addition is performed on the image signals from the pixels in which the first line is arranged alternately with the second and third lines in the orthogonal direction orthogonal to the diagonal direction and the analog addition result is designated as the output signal.

Further, according to the first embodiment of the present technology, the pixels constituting each pixel group may share one floating diffusion, and pixel signals of each pair of pixels of spectral sensitivity may be subjected to the analog addition by controlling exposure start and end timings for each pair of pixels of each spectral sensitivity. Thereby, there is an effect that the analog addition is performed on pixel signals of each pair of pixels of spectral sensitivity by controlling exposure start and end timings for each pair of pixels of spectral sensitivity.

Further, according to the first embodiment of the present technology, the pixels of the first spectral sensitivity may be green (G) pixels, the pixels of the second spectral sensitivity may be red (R) pixels, and the pixels of the third spectral sensitivity may be blue (B) pixels. Thereby, there is an effect that the analog addition is performed on the image signals from the G; R, and B pixels and the analog addition result is designated as the output signal.

Further, according to a second embodiment, there is provided an imaging apparatus and an imaging method thereof including an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal, and an image processing section configured to perform image processing using first image data formed by an image signal subjected to the analog addition on the one pair of pixels of the first spectral sensitivity, second image data formed by an image signal subjected to the analog addition on the one pair of pixels of the second spectral sensitivity, and third image data formed by an image signal subjected to the analog addition on the one pair of pixels of the third spectral sensitivity. Thereby, there is an effect that the analog addition is performed on the image signals from the pixels for each pair of pixels of spectral sensitivity constituting each pixel group, the analog addition result is designated as the output signal, and image processing is performed using output signals.

Further, according to the second embodiment of the present technology, the image processing section may perform the image processing using a first frame formed by the first image data and a second frame formed by the second image data and the third image data. Thereby, there is an effect that the image processing is performed using the first frame formed by the first image data and the second frame formed by the second image data and the third image data.

Further, according to the second embodiment of the present technology, in the second frame, a line formed by the second image data and a line formed by the third image data may be alternately arranged in a diagonal direction. Thereby, there is an effect that the image processing is performed using the second frame in which a line formed by the second image data and a line formed by the third image data are alternately arranged in the diagonal direction.

Further, according to a third embodiment, there is provided an electronic device and an imaging method thereof including an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal. An image processing section configured to perform image processing using first image data formed by an image signal subjected to the analog addition on the one pair of pixels of the first spectral sensitivity, second image data formed by an image signal subjected to the analog addition on the one pair of pixels of the second spectral sensitivity, and third image data formed by an image signal subjected to the analog addition on the one pair of pixels of the third spectral sensitivity, and a control section configured to control image data subjected to the image processing to be output or recorded. Thereby, there is an effect that the analog addition is performed on the image signals from the pixels for each pair of pixels of spectral sensitivity constituting each pixel group, the analog addition result is designated as the output signal, image processing is performed using output signals, and output control or recording control of image data subjected to the image processing is performed.

In accordance with the embodiments of the present technology, there is an excellent effect that a load imposed on image processing can be reduced.

### BRIEF DESCRIPTION OF THE DRAWINGS

FIG. 1 is a diagram illustrating an example of a pixel arrangement of color filters (CFs) mounted on a light receiving section of an image sensor 100 in accordance with a first embodiment of the present technology;

FIG. 2 is a diagram illustrating a configuration example of a basic circuit of a pixel provided in the image sensor 100 in accordance with the first embodiment of the present technology;

FIG. 3 is a diagram illustrating a configuration example of a pixel control circuit and a pixel wiring of the image sensor 100 in accordance with the first embodiment of the present technology;

FIG. 4 is a diagram illustrating a configuration example of a pixel control circuit and a pixel wiring of the image sensor 100 in accordance with the first embodiment of the present technology;

FIG. 5 is a timing chart schematically illustrating control signals for pixels constituting the image sensor 100 in accordance with the first embodiment of the present technology;

FIG. 6 is a block diagram illustrating a functional configuration example of an imaging apparatus 600 in accordance with the first embodiment of the present technology;

FIG. 7 is a diagram schematically illustrating a flow of image processing that is performed in the imaging apparatus 600 in accordance with the first embodiment of the present technology;

FIG. 8 is a diagram illustrating an example of a pixel arrangement of CFs mounted on a light receiving section of the image sensor 100 in accordance with a second embodiment of the present technology;

FIG. 9 is a timing chart schematically illustrating control signals for pixels constituting the image sensor 100 in accordance with the second embodiment of the present technology; and

FIG. 10 is a diagram schematically illustrating a flow of image processing that is performed in the imaging apparatus 600 in accordance with the second embodiment of the present technology.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, modes (hereinafter referred to as embodiments) for carrying out the present technology will be described. Description will be given in the following order.

### 1. First Embodiment

(Example in Which Image Signals from Pixels within Pixel Shared Unit Are Analog-Added for Every Same Type of Pixels and Analog-Addition Result Is Designated as Output Signal)

### 2. Second Embodiment

(Example of Image Sensor that Reads Plurality of Pixels by Periodically Changing Exposure Period)

### 1. First Embodiment

### [Pixel Arrangement Example of CFs]

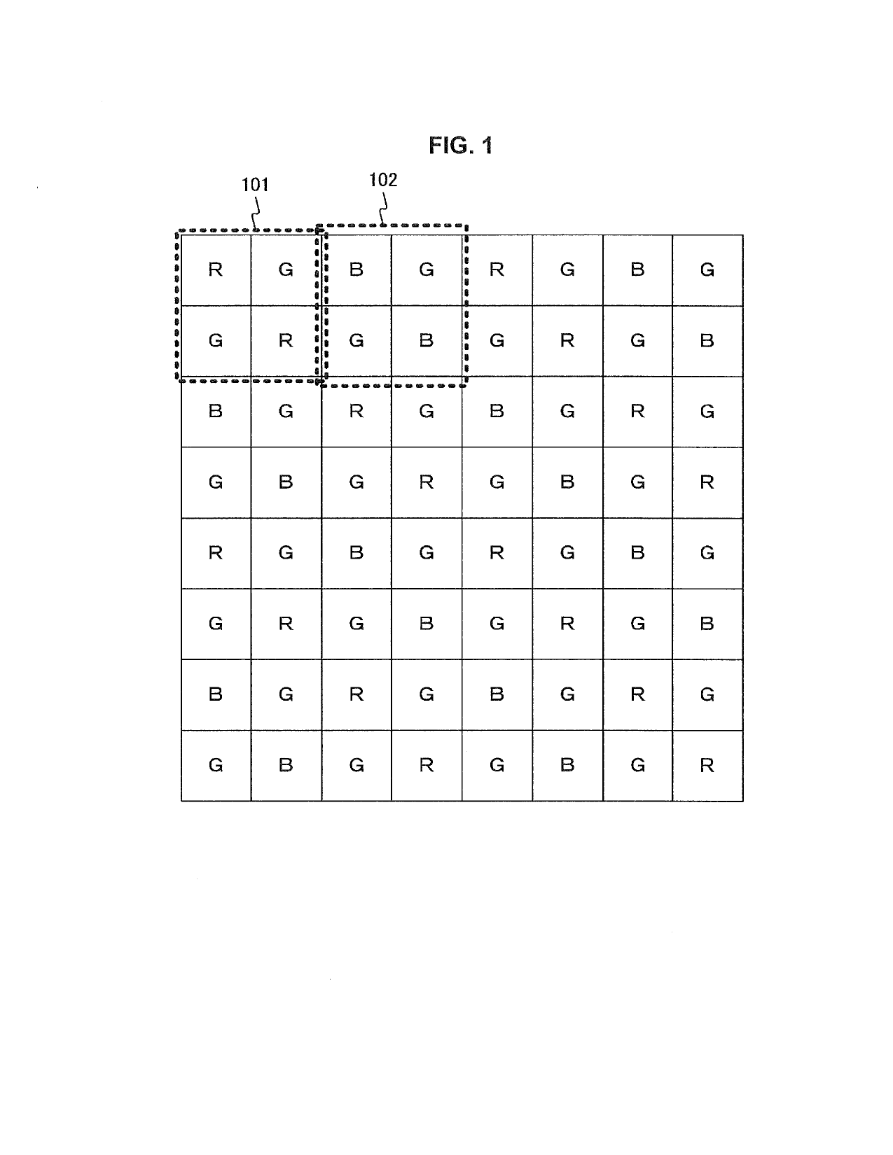

FIG. 1 is a diagram illustrating an example of a pixel arrangement of CFs mounted on a light receiving section of an image sensor 100 in accordance with the first embodiment of the present technology. In FIG. 1, each rectangle schematically represents a pixel.

In addition, in the first embodiment of the present technology, an example of CFs with three colors of RGB including G R, and B is shown. In addition, reference signs inside each rectangle indicate a type of CF.

Here, dotted rectangular frames 101 and 102 illustrated in FIG. 1 represent pixel shared units each having a floating diffusion (FD) shared by a plurality of pixels. In FIG. 1, an example in which a pixel group of a matrix shape having two pixels arranged in a horizontal direction (specific direction) and two pixels arranged in a vertical direction is designated as the pixel shared unit is illustrated. In addition, a position in a pixel shared unit of one pair of G pixels within the dotted rectangular frame 101 is identical to a position in a pixel shared unit of one pair of G pixels within the dotted rectangular frame 102. That is, in the pixel shared unit, two pixels in a diagonal direction are arranged to have the same color. Pixel shared units including one pair of G pixels and one pair of R pixels and pixel shared units including one pair of G pixels and one pair of B pixels are arranged in a checkered pattern.

In addition, a line (first line) formed by G pixels in the diagonal direction, a line (second line) formed by R pixels in the diagonal direction, and a line (third line) formed by B pixels in the diagonal direction are alternately arranged. That is, the first line is arranged alternately with the second and third lines in an orthogonal direction orthogonal to the diagonal direction.

In the first embodiment of the present technology, an example in which pixels of first spectral sensitivity are designated as G pixels, pixels of second spectral sensitivity are designated as R pixels, and pixel of third spectral sensitivity are designated as B pixels is shown.

### [Configuration Example of Basic Circuit of Pixel]

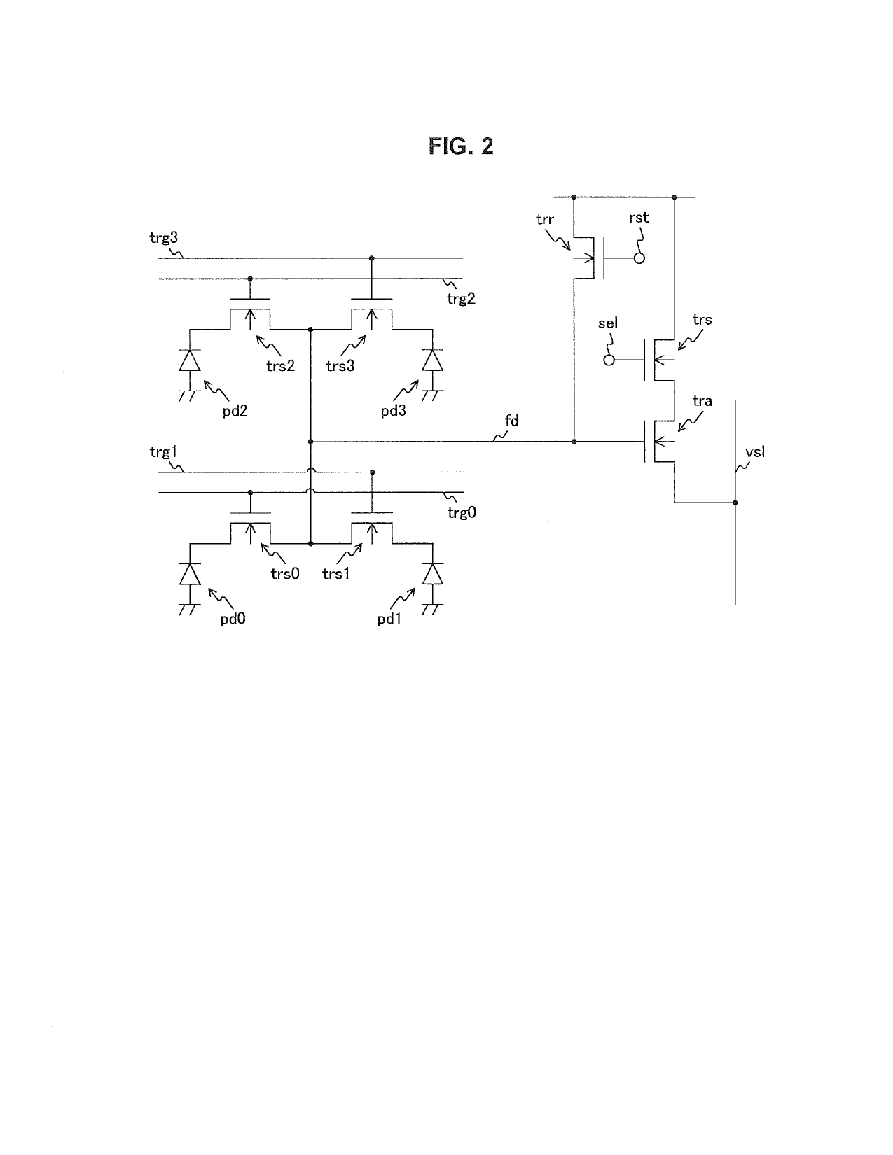

FIG. 2 is a diagram illustrating the configuration example of the basic circuit of a pixel provided in the image sensor 100 in accordance with the first embodiment of the present technology.

Here, because pixel size reduction has recently progressed, a method in which a plurality of pixels share an FD has been used. In FIG. 2, a configuration example of a pixel circuit in which four pixels (two longitudinal pixels×two lateral pixels) share the FD is illustrated.

The image sensor 100 includes photodiodes (PDs) pd0 to pd3, which are light receiving sections, an FD fd, and pixel transfer transistors trs0 to trs3. That is, the four-pixel shared pixel circuit in which the PDs pd0 to pd3 are connected to the one FD fd via the pixel transfer transistors trs0 to trs3 is shown. In addition, the image sensor 100 includes an amplification transistor tra, a reset transistor trr, and a selection transistor trs.

In addition, these pixels are connected to pixel transfer control signal lines (pixel transfer gate control signal lines) trg0 to trg3, a pixel read selection control signal line sel, a vertical signal line (read line) vsl, and a pixel reset control signal line rst.

Light with which a pixel is irradiated is converted into electrons in the PDs pd0 to pd3, and charges corresponding to an amount of light are accumulated in the PDs pd0 to pd3. In addition, the pixel transfer transistors trs0 to trs3 control charge transfers between the PDs pd0 to pd3 and the FD fd. Signals of the pixel transfer control signal lines trg0 to trg3 are applied to gate electrodes of the pixel transfer transistors trs0 to trs3, and hence charges accumulated in the PDs pd0 to pd3 are transferred to the FD fd.

The FD fd is connected to a gate electrode of the amplification transistor tra. If a control signal of the pixel read selection control signal line set is applied to a gate electrode of the selection transistor trs, a voltage corresponding to charges accumulated in the FD fd can be read as a signal from the vertical signal line vsl.

If a reset signal of the pixel reset control signal line rst is applied to a gate electrode of the reset transistor trr, a charge accumulation state is reset because the charges accumulated in the FD fd flow through the reset transistor trr.

Here, an effect obtained by sharing the FD fd will be described. For example, in general, charges are transferred from the PDs pd to the FD fd pixel by pixel, a micro potential change is amplified via an amplification circuit, and a voltage change is read by A/D conversion. On the other hand, because charges of a plurality of pixels can be simultaneously transferred to the FD fd when the FD fd is shared, addition information of the plurality of pixels can be read by one A/D conversion process. As described above, it is possible to double a frame rate and improve a signal to noise ratio (SNR) using an addition reading method of the FD fd.

### [Configuration Example of Pixel Control Circuit and Pixel Wiring]

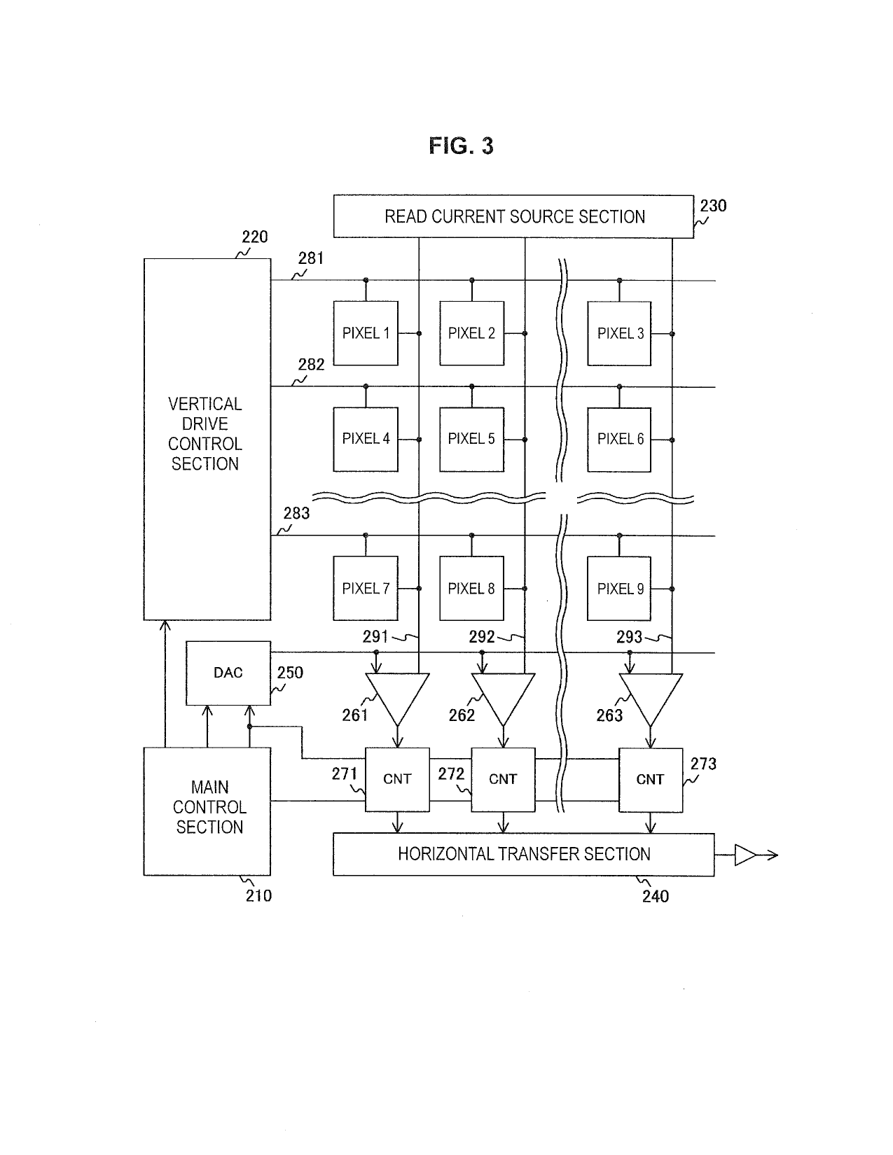

FIG. 3 is a diagram illustrating the configuration example of the pixel control circuit and the pixel wiring of the image sensor 100 in accordance with the first embodiment of the present technology.

The image sensor 100 includes pixels 1 to 9, a main control section 210, a vertical drive control section 220, a read current source section 230, a horizontal transfer section 240, a digital/analog (D/A) converter (DAC) 250, comparators 261 to 263, and counter circuits (CNTs) 271 to 273. Only some parts are illustrated for the pixels 1 to 9, the comparators 261 to 263, and the CNTs 271 to 273, and the other parts are omitted.

The pixels 1 to 9 correspond to the pixels illustrated in FIG. 1 and the pixels illustrated in FIG. 2, and are arranged in a matrix shape.

The main control section 210 controls each section in the image sensor 100 based on a control program stored in a memory (not illustrated). For example, the main control section 210 issues an instruction for designating a row to be read to the vertical drive control section 220. In addition, the main control section 210 distributes clocks to the DAC 250 and the CNTs 271 to 273.

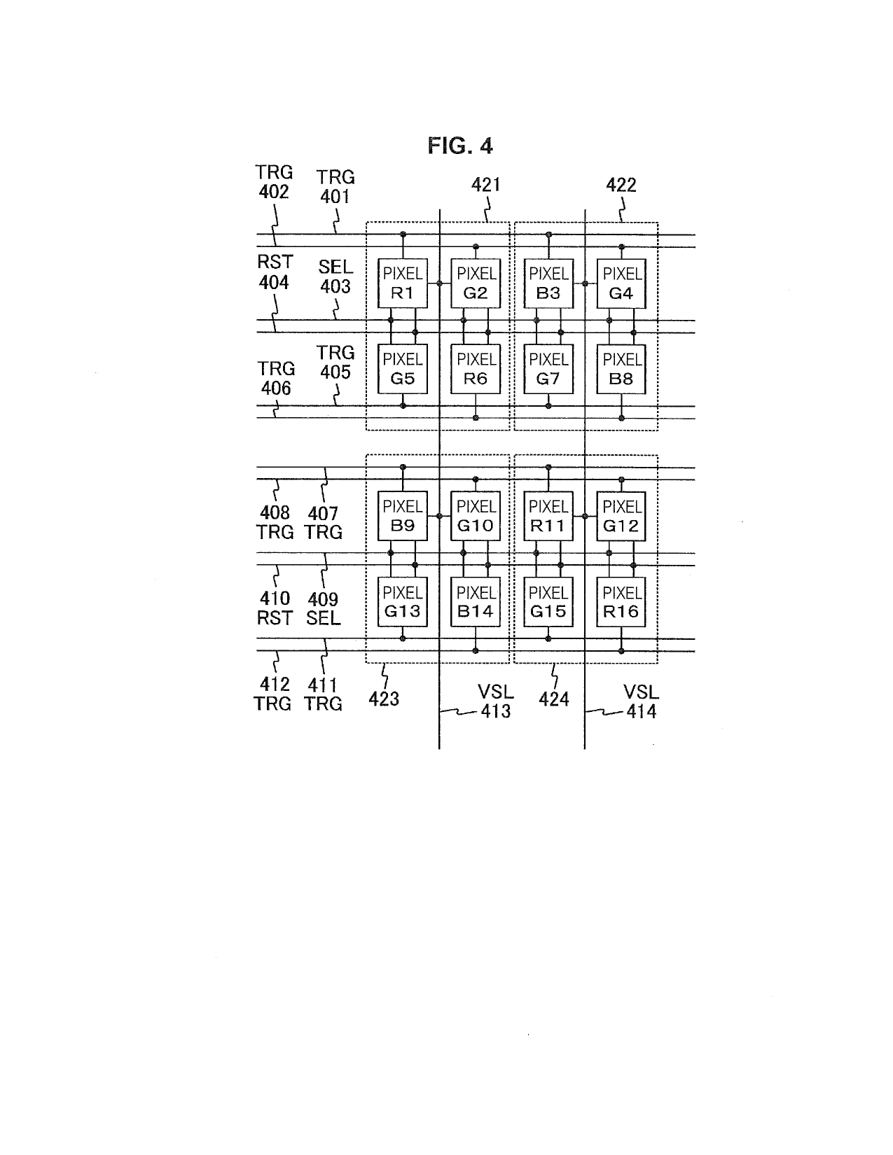

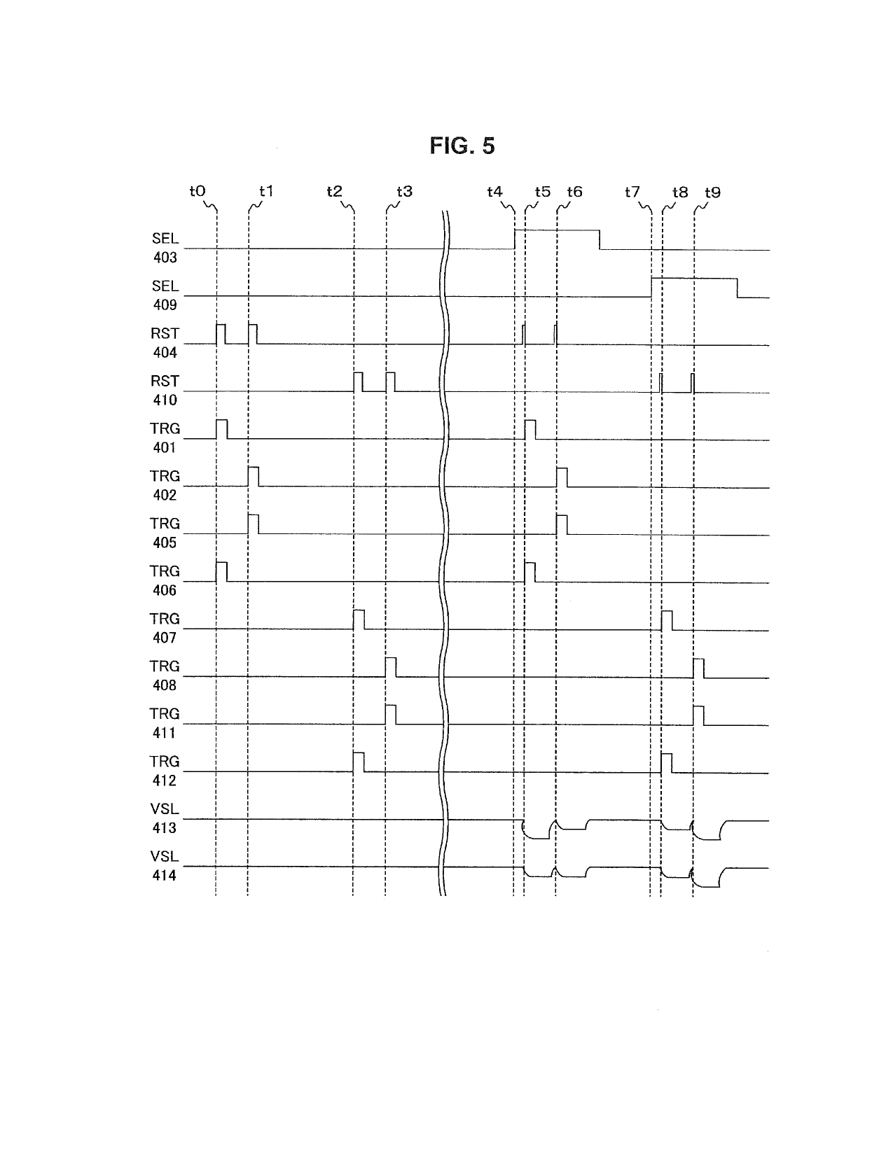

The vertical drive control section 220 turns on/off switches between the pixels and vertical signal lines (VSL) 291 to 293 by controlling signal lines 281 to 283 (RST, TRG, and SEL) wired in a row direction based on an instruction from the main control section 210. When the switch between the pixel and the vertical signal line VSL has been turned on, a potential of the vertical signal line VSL is changed by charges accumulated in the pixel. As described above, the vertical drive control section 220 controls the signal lines, and hence a series of read control operations on pixels are performed. The signal lines will be described in detail with reference to FIG. 4. In addition, the control of the signal lines will be described in detail with reference to FIG. 5.

The read current source section 230 supplies operation currents (read currents) for reading pixel signals to the pixels 1 to 9.

The DAC 250 supplies ramp waves to the comparators 261 to 263 based on the clock distributed from the main control section 210.

The comparator 261 compares the ramp wave supplied from the DAC 250 to a potential of the vertical signal line (VSL) 291, and the comparison result between the ramp wave and the potential of the vertical signal line (VSL) 291 is output to the CNT 271. Because the comparators 262 and 263 are also substantially the same as the comparator 261, description thereof is omitted here.

The CNT 271 counts a comparison time of the comparator 261, and holds the count result. When the comparison result indicating that the ramp wave supplied from the DAC 250 has intersected the potential of the vertical signal line (VSL) 291 has been output from the comparator 261, the CNT 271 stops a count operation and ends AID conversion. Because the CNTs 272 and 273 are also substantially the same as the CNT 271, description thereof is omitted here.

The horizontal transfer section 240 horizontally transfers count results held in the CNTs 271 to 273 as image data (digital data) after A/D conversion of all columns has ended by the CNTs 271 to 273.

### [Configuration Example of Pixel Control Circuit and Pixel Wiring]

FIG. 4 is a diagram illustrating the configuration example of the pixel control circuit and the pixel wiring of the image sensor 100 in accordance with the first embodiment of the present technology. In FIG. 4, only pixels and wirings of the configurations of the pixel control circuit and the pixel wiring illustrated in FIG. 3 are illustrated and the illustration of the other configurations is omitted.

A plurality of pixels (pixels R1 to R16) illustrated in FIG. 4 have the structure illustrated in FIG. 2, and are arranged in a two-dimensional (2D) square lattice shape in the image sensor 100. In addition, CF types R, G and B and identification numbers 1 to 16 are assigned inside rectangles representing pixels.

In addition, as illustrated in FIG. 4, four pixels sharing one FD are each surrounded dotted rectangular frames 421 to 424. For example, each pixel within the dotted rectangular frame 421 corresponds to one pixel within the dotted rectangular frame 101 illustrated in FIG. 1. In addition, each pixel within the dotted rectangular frame 422 corresponds to one pixel within the dotted rectangular frame 102 illustrated in FIG. 1.

For lines in the horizontal direction, pixel transfer control signal lines (TRG) 401, 402, and the like, a pixel read selection control signal line (SEL) 403 and the like, and a pixel reset control signal line (RST) 404 and the like are wired. As described above, the vertical drive control section 220 controls selection of each signal line and hence one certain pixel can be designated as an output target. Thus, it is possible to read signals of all pixels in time division while the pixels are sequentially selected. These signal lines correspond to the signal lines 281 to 283 illustrated in FIG. 3.

In addition, vertical signal lines (VSL) 413 and 414 are wired in a vertical column direction, and pixels on the same vertical column share one read line. The vertical signal lines (VSL) 413 and 414 correspond to the vertical signal lines (VSL) 291 to 293 illustrated in FIG. 3.

### [Timing Chart Example of Control Signals]

FIG. 5 is a timing chart schematically illustrating control signals for pixels constituting the image sensor 100 in accordance with the first embodiment of the present technology. In FIG. 5, the timing chart corresponding to the pixels R1 to R16 illustrated in FIG. 4 is illustrated. In addition, a horizontal axis illustrated in FIG. 5 is a time axis. Each waveform illustrated in FIG. 5 denoted by the same reference sign as in a corresponding signal line illustrated in FIG. 4 will be described.

First, at the timing of time t0, the pixel reset control signal line (RST) 404 and pixel transfer control signal lines (MG) 401 and 406 are turned on (active at a high (H) level). Thereby, the pixels R1 and R6 are simultaneously reset. After this reset operation ends, the pixels R1 and R6 start an accumulation operation. Likewise, at the timing of time t0, the pixels B3 and B8 are simultaneously reset. After this reset operation ends, the pixels B3 and B8 start the accumulation operation.

Subsequently, at the timing of time t1, the pixel reset control signal line (RST) 404 and pixel transfer control signal lines (TRG) 402 and 405 are turned on. Thereby, the pixels G2 and G5 are simultaneously reset. After this reset operation ends, the pixels G2 and G5 start the accumulation operation. Likewise, at the timing of time t1, the pixels G4 and G7 are simultaneously reset. After this reset operation ends, the pixels G4 and G7 start the accumulation operation.

Subsequently, at the timing of time t2, a pixel reset control signal line (RST) 410 and pixel transfer control signal lines (TRG) 407 and 412 are turned on. Thereby, the pixels B9 and B14 are simultaneously reset. After this reset operation ends, the pixels B9 and B14 start the accumulation operation. Likewise, at the timing of time t2, the pixels R11 and R16 are simultaneously reset. After this reset operation ends, the pixels R11 and R16 start the accumulation operation.

Subsequently, at the timing of time t3, the pixel reset control signal line (RST) 410 and pixel transfer control signal lines (TRG) 408 and 411 are turned on. Thereby, the pixels G10 and G13 are simultaneously reset. After this reset operation ends, the pixels G10 and G13 start the accumulation operation. Likewise, at the timing of time t3, the pixels G12 and G15 are simultaneously reset. After this reset operation ends, the pixels G12 and G15 start the accumulation operation.

Here, time intervals between timings (times t0 to t3) of the reset operations and timings of the read operations are controlled to be a constant time in the pixels. Thereby, exposure periods (accumulation times) of all pixels are identical.

Subsequently, the pixel read selection control signal line (SEL) 403 is turned on at the timing of time t4, and the pixel transfer control signal lines (TRG) 401 and 406 are turned on at the timing of time t5. Thereby, charges of the pixels R1 and R6 are transferred to the shared FD. Likewise, at the timing of time t5, charges of the pixels B3 and B8 are also transferred to the shared FD. Thereby, voltages of the vertical signal lines (VSL) 413 and 414 connected to the FDs via the amplifiers are changed. A change amount is an addition amount of charges accumulated in the pixels R1 and R6 and the pixels B3 and B8.

Subsequently, at the timing of time t6, the pixel transfer control signal lines (TRG) 402 and 405 are turned on, and charges of the pixels G2 and G5 are transferred to the shared FD. Likewise, at the timing of time t6, charges of the pixels G4 and G7 are transferred to the shared FD. Thereby, the voltages of the vertical signal lines (VSL) 413 and 414 connected to the FDs via the amplifiers are changed.

Subsequently, the pixel read selection control signal line (SEL) 409 is turned on at the timing of time t7, and the pixel transfer control signal lines (TRG) 407 and 412 are turned on at the timing of time t8. Thereby, charges of the pixels B9 and B14 are transferred to the shared FD. Likewise, at the timing of time t8, charges of the pixels R11 and R16 are transferred to the shared FD. Thereby, the voltages of the vertical signal lines (VSL) 413 and 414 connected to the FDs via the amplifiers are changed.

Subsequently, at the timing of time t9, the pixel transfer control signal lines (TRG) 408 and 411 are turned on and charges of the pixels B9 and B14 are transferred to the shared FD. Likewise, at the timing of time t9, charges of the pixels R11 and R16 are transferred to the shared FD. Thereby, the voltages of the vertical signal lines (VSL) 413 and 414 connected to the FDs via the amplifiers are changed.

As described above, according to a series of operations, an amplified potential obtained by adding charge amounts of pixels of the same color in the diagonal direction among four pixels constituting the pixel shared unit is output to one of the connected vertical signal lines (VSL) 413 and 414.

That is, in the image sensor 100, a first pixel group (pixel shared unit) in which one pair of G pixels and one pair of R pixels are diagonally arranged and a second pixel group (pixel shared unit) in which one pair of G pixels and one pair of

B pixels are diagonally arranged are arranged in a lattice shape. The image sensor 100 performs analog addition on image signals from pixels for each pair of the same type of pixels constituting each pixel group (pixel shared unit), and designates the analog addition result as an output signal.

In addition, in the image sensor 100, one FD is shared by pixels constituting each pixel group (pixel shared unit). The analog addition is performed on pixel signals of each pair of the same type of pixels constituting each pixel group (pixel shared unit) by controlling exposure start and end timings for each pair of the same type of pixels constituting each pixel group (pixel shared unit).

In addition, the first embodiment of the present technology can be recognized as an imaging method of performing analog addition on image signals from pixels for each pair of the same type of pixels constituting each pixel group (pixel shared unit), and designating the analog addition result as an output signal in the image sensor 100.

In addition, the image processing section performs various image processing on an image signal (output signal) output by analog addition as described above. Hereinafter, an example of image processing to be performed in the imaging apparatus 600 having the image sensor 100 will be described.

### [Functional Configuration Example of Imaging Apparatus]

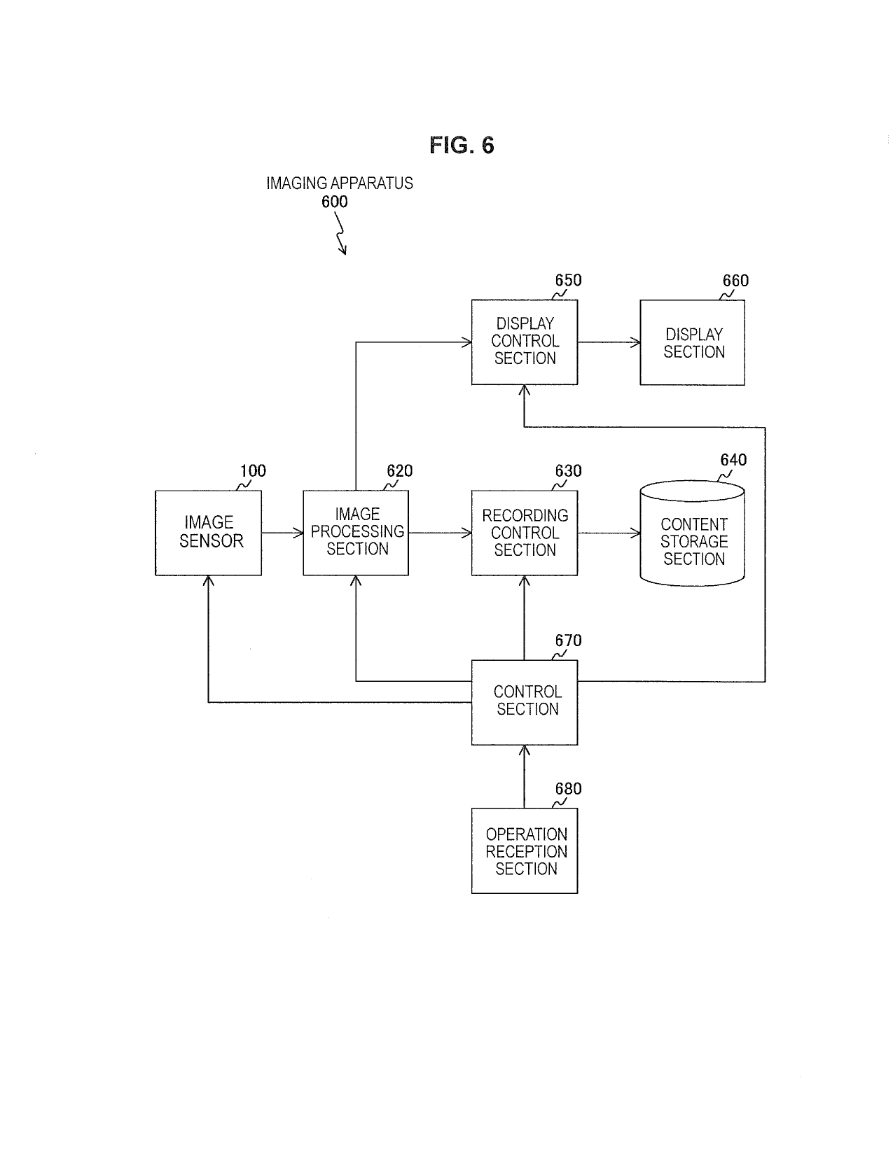

FIG. 6 is a block diagram illustrating the functional configuration example of the imaging apparatus 600 in accordance with the first embodiment of the present technology.

The imaging apparatus 600 includes the image sensor 100, an image processing section 620, a recording control section 630, a content storage section 640, a display control section 650, a display section 660, a control section 670, and an operation reception section 680.

The image sensor 100 generates an image signal based on an instruction of the control section 670, and outputs the generated image signal to the image processing section 620. Specifically, the image sensor 100 converts light of an object incident via an optical system (not illustrated) into an electrical signal. In addition, the optical system includes a lens group, which focuses incident light from the object and a diaphragm, and the light focused by the lens group is incident to the image sensor 100 via the diaphragm.

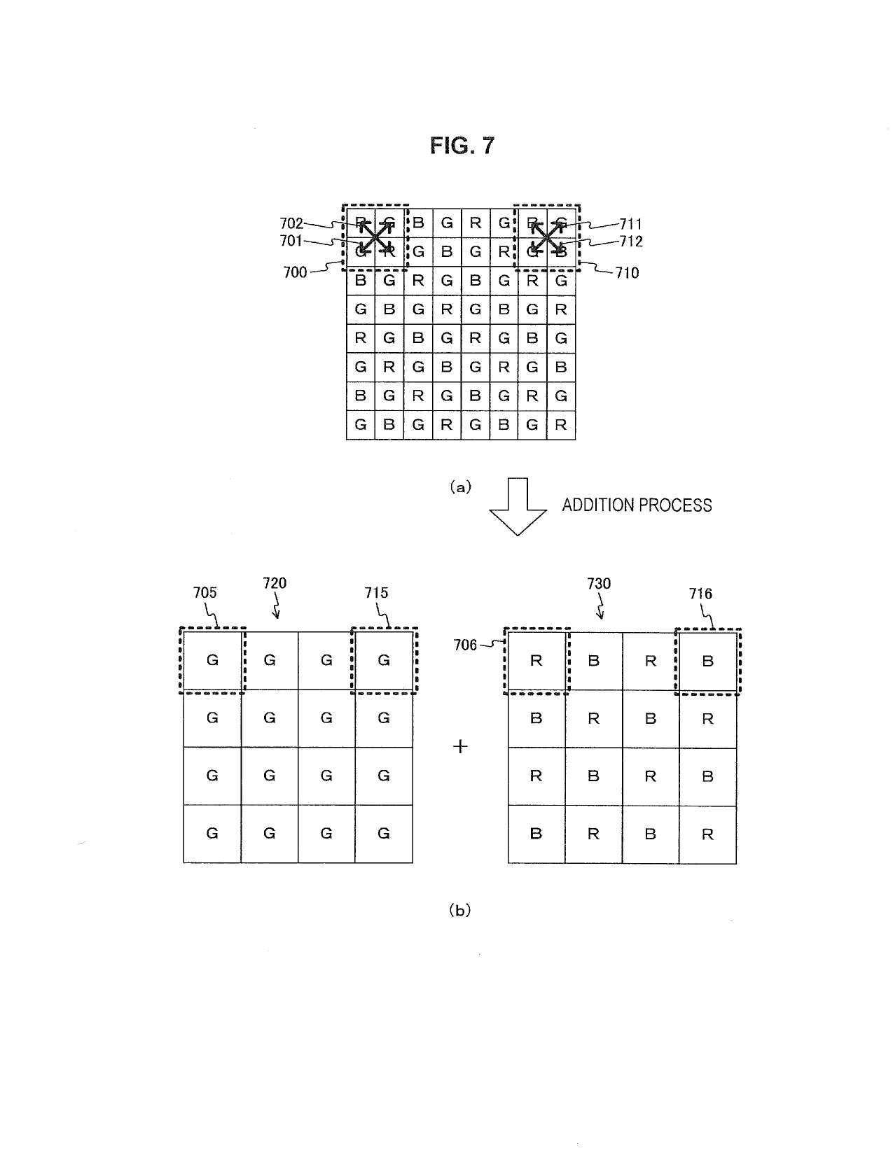

The image processing section 620 performs various image processing on an image signal (digital signal) output from the image sensor 100 based on an instruction of the control section 670. The image processing section 620 outputs the image signal (image data) subjected to various image processing to the recording control section 630 and the display control section 650. This image processing will be described in detail with reference to FIG. 7.

The recording control section 630 performs recording control on the content storage section 640 based on an instruction of the control section 670. For example, the recording control section 630 causes the content storage section 640 to record an image (image data) output from the image processing section 620 as image content (a still-image file or a moving-image file).

The content storage section 640 is a recording medium that stores various information (image content and the like) based on control of the recording control section 630. The content storage section 640 may be embedded in the imaging apparatus 600, and may be attachable to or detachable from the imaging apparatus 600.

The display control section 650 causes the display section 660 to display an image output from the image processing section 620 based on an instruction of the control section 670. For example, the display control section 650 causes the display section 660 to display a display screen for performing various operations related to an imaging operation or an image (so-called through image) generated by the image sensor 100.

The display section 660 is a display panel that displays each image based on control of the display control section 650.

The control section 670 controls each section in the imaging apparatus 600 based on a control program stored in a memory (not illustrated). For example, the control section 670 performs output control (display control) or recording control of an image signal (image data) subjected to image processing by the image processing section 620.

The operation reception section 680 receives an operation performed by a user, and outputs a control signal (operation signal) corresponding to received operation content to the control section 670.

### [Image Processing Example]

FIG. 7 is a diagram schematically illustrating a flow of image processing that is performed in the imaging apparatus 600 in accordance with the first embodiment of the present technology.

An example of a pixel arrangement of CFs mounted on the light receiving section of the image sensor 100 is illustrated in FIG. 7(a). The pixel arrangement of FIG. 7(a) is substantially the same as the pixel arrangement illustrated in FIG. 1 or the like.

In FIG. 7(b), a configuration example of an arrangement of output data (output signals) after analog addition has been performed on pixels illustrated in FIG. 7(a) is illustrated.

First, four pixels (a pixel shared unit) within a dotted rectangular frame 700 illustrated in FIG. 7(a) will be described. When two G pixels (G pixels connected by an arrow 701) among the four pixels within the rectangle 700 have been subjected to the analog addition, a centroid position of an addition signal is designated as a center position of the four pixels within the dotted rectangular frame 700. Likewise, even when two G pixels (G pixels connected by an arrow 711) among four pixels within a dotted rectangular frame 710 illustrated in FIG. 7(a) have been subjected to the analog addition, a centroid position of an addition signal is designated as a center position of the four pixels within the dotted rectangular frame 710.

Here, two G pixels are necessarily present among four pixels constituting a pixel shared unit (a minimum unit shared by pixels). Thus, a centroid position of an output after the analog addition on the G pixels becomes a center position shared by four pixels. That is, as illustrated in FIG. 7(b), data positioned in the center shared by four pixels after the analog addition on the G pixels is uniformly arranged without a gap on a space of resolution halved in vertical and horizontal directions.

A dotted rectangular frame 705 illustrated in FIG. 7(b) corresponds to output data after the analog addition on two G pixels (the G pixels connected by the arrow 701) within the rectangle 700 illustrated in FIG. 7(a). In addition, a dotted rectangular frame 715 illustrated in FIG. 7(b) corresponds to output data after the analog addition on two G pixels (the G pixels connected by the arrow 711) within the rectangle 710 illustrated in FIG. 7(a).

In addition, there are two R or B pixels other than the G pixels within the pixel shared unit. Even for the two R or B pixels, as in the G pixels, a centroid position of an addition signal becomes a position that is completely the same as that of the G pixels according to the analog addition. For example, when the analog addition has been performed on the two R pixels (R pixels connected by an arrow 702) among four pixels within the dotted rectangular frame 700 illustrated in FIG. 7(a), a centroid position of an addition signal becomes a center position of the four pixels within the dotted rectangular frame 700. Likewise, when the analog addition has been performed on two B pixels (B pixels connected by an arrow 712) among four pixels within the dotted rectangular frame 710 illustrated in FIG. 7(a), a centroid position of an addition signal becomes a center position of the four pixels within the dotted rectangular frame 710.

A dotted rectangular frame 706 illustrated in FIG. 7(b) corresponds to output data after the analog addition on two R pixels (the R pixels connected by the arrow 702) within the rectangle 700 illustrated in FIG. 7(a). In addition, a dotted rectangular frame 716 illustrated in FIG. 7(b) corresponds to output data after the analog addition on two B pixels (the B pixels connected by the arrow 712) within the rectangle 710 illustrated in FIG. 7(a).

As described above, even for R and B pixels, outputs are generated so that centroid positions are the same as that of the G pixels within the pixel shared unit. However, in the case of the R and B pixels, the R and B pixels are arranged in a checkered pattern as illustrated in FIG. 7(b).

That is, as illustrated in FIG. 7(b), image data (first image data) of G pixels is formed by an image signal after the analog addition on one pair of G pixels. For example, a first frame 720 is formed by the first image data. In addition, image data (second image data) of R pixels is formed by an image signal after the analog addition on one pair of R pixels. In addition, image data (third image data) of B pixels is formed by an image signal after the analog addition on one pair of B pixels. For example, a second frame 730 is formed by the second image data and the third image data. In the second frame 730, for example, a line formed by image data (second image data) of R pixels and a line formed by image data (third image data) of B pixels are alternately arranged in the diagonal direction.

In addition, the image processing section 620 can perform image processing (for example, de-mosaic processing) using the image data (for example, the first frame 720 and the second frame 730 illustrated in FIG. 7(b)). In addition, the control section 670 may use the data for the other processing by holding the data.

For example, the case in which a process (de-mosaic processing) of converting image data illustrated in FIG. 7(b) into RBG pixels is performed is assumed. In this case, because G pixels are vertically and horizontally added and a centroid position also becomes a signal of a desired position, it is not necessary to perform a special calculation process. Thus, a calculation process related to the G pixels can be reduced. In addition, it is not necessary to perform centroid processing even on R and B pixels. An empty space pixel area in a checkered pattern can be easily estimated from peripheral pixels in which data exists. In addition, RGB conversion can be easily performed by holding the data.

When image processing of RGB conversion and the like is performed on image signals subjected to the addition process as described above, the calculation process can be significantly reduced. Thus, an image processing circuit can be significantly reduced.

As described above, in the first embodiment of the present technology, for example, in a CMOS sensor, pixels of the same color positioned in the diagonal direction can be simultaneously subjected to the analog addition and read using CFs arranged in a non-Bayer arrangement. For example, addition reading is possible in an arrangement of CFs as illustrated in FIG. 1. In addition, it is possible to double a frame rate according to the addition reading as described above and improve an SNR according to the analog addition. In addition, because the centroid of pixels after the analog addition can be designated as a center position of four shared pixels, centroid processing is not necessary and a load imposed on image processing can be reduced. In addition, because an accurate centroid position can be used, the quality of an image can be improved. As described above, addition reading of CFs in a diagonal arrangement of RGB can be implemented.

### 2. Second Embodiment

In the first embodiment of the present technology, an example of addition reading when exposure periods of pixels are identical has been described. Here, an image sensor that reads a plurality of pixels by periodically changing an exposure period is proposed.

In the second embodiment of the present technology, an example of the image sensor that reads a plurality of pixels by periodically changing an exposure period is shown. A configuration of the image sensor in accordance with the second embodiment of the present technology is substantially the same as the examples illustrated in FIGS. 1 to 3 and the like. Thus, description of sections common to the first embodiment of the present technology is partially omitted.

### [Pixel Arrangement Example of CFs]

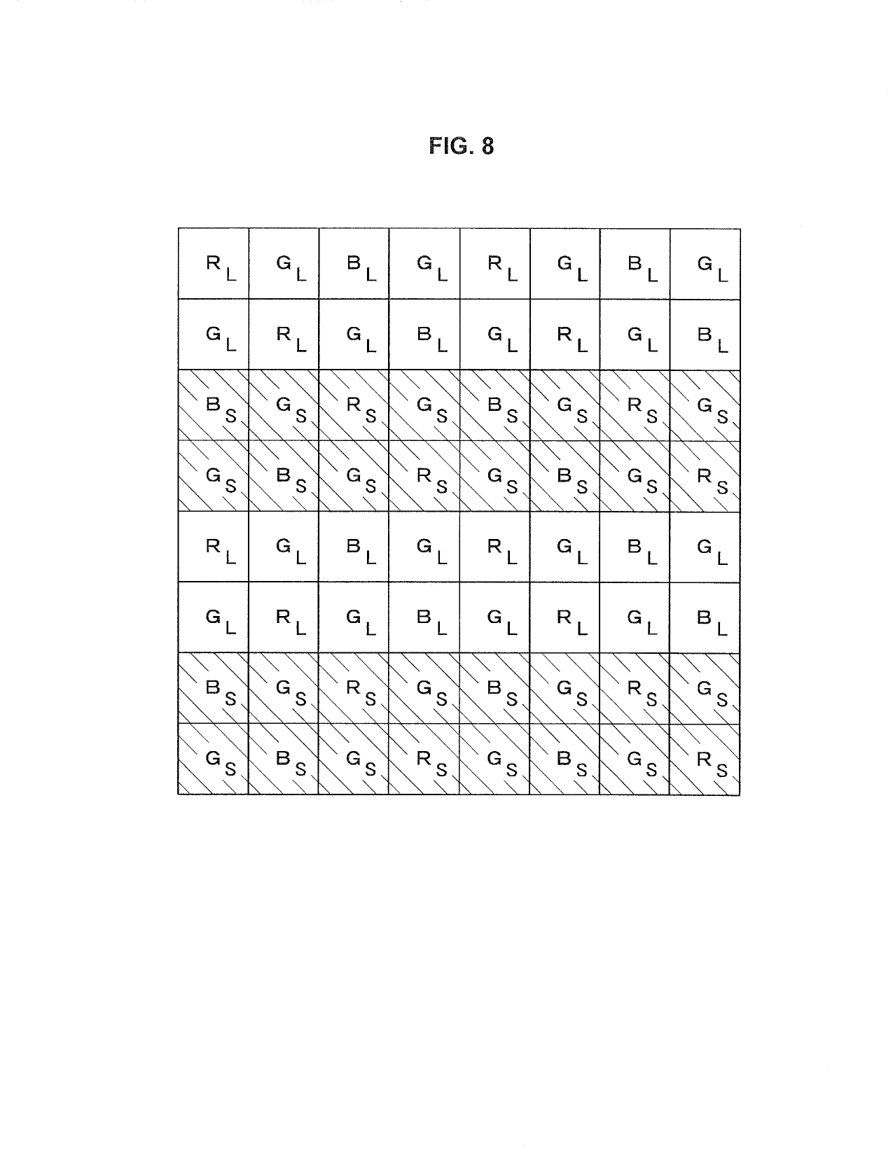

FIG. 8 is a diagram illustrating an example of a pixel arrangement of CFs mounted on a light receiving section of the image sensor 100 in accordance with the second embodiment of the present technology. FIG. 8 illustrates the pixel arrangement example when a spatially varying exposure (SVE) addition reading method is performed in the pixel arrangement of CFs illustrated in FIG. 1.

Here, in imaging within one frame, all pixels are generally captured in the same exposure period. On the other hand, the SVE is an imaging method of performing imaging by periodically changing the exposure period within one frame in imaging within one frame and implementing the effect of a wide dynamic range using signal processing technology. In FIG. 8, an example of two types of exposure periods (long-time exposure and short-time exposure) is illustrated.

Here, a pixel to be subjected to long-time exposure is referred to as a long-time-exposure pixel, and a pixel to be subjected to short-time exposure is referred to as a short-time-exposure pixel in the description to be made here. That is, the long-time-exposure pixel is a pixel to be read by continuous exposure (long-time exposure) within a predetermined exposure period. In addition, the short-time-exposure pixel is a pixel on which intermittent exposure (short-time exposure) is performed within a predetermined exposure period and from which reading is performed at each exposure time.

In addition, as illustrated in FIG. 8, the inside of a rectangle of a pixel to be subjected to the long-time exposure is not hatched with diagonal lines and the inside of a pixel to be subjected to the short-time exposure is hatched with diagonal lines. In addition, reference sign indicating a type of CF is shown in the inside of each rectangle. For example, among G pixels, “G_{L}” is assigned to a long-time-exposure pixel and “G_{S}” is assigned to a short-time-exposure pixel. In addition, among R pixels, “R_{L}” is assigned to a long-time-exposure pixel and “R_{S}” is assigned to a short-time-exposure pixel. Further, among B pixels, “B_{L}” is assigned to a long-time-exposure pixel and “B_{S}” is assigned to a short-time-exposure pixel.

As described above, in the example illustrated in FIG. 8, a first pixel group (short-time-exposure pixel group) and a second pixel group (long-time-exposure pixel group) are alternately arranged for every two lines in the vertical direction. In addition, among lines formed by pixel shared units in the horizontal direction (specific direction), lines formed by long-time-exposure groups (two lines not hatched with diagonal lines) are designated as first lines. In addition, among the lines formed by the pixel shared units in the horizontal direction, lines formed by short-time-exposure groups (two lines hatched with diagonal lines) are designated as second lines. In this case, a set of the first lines and a set of the second lines are alternately arranged in the vertical direction (orthogonal direction).

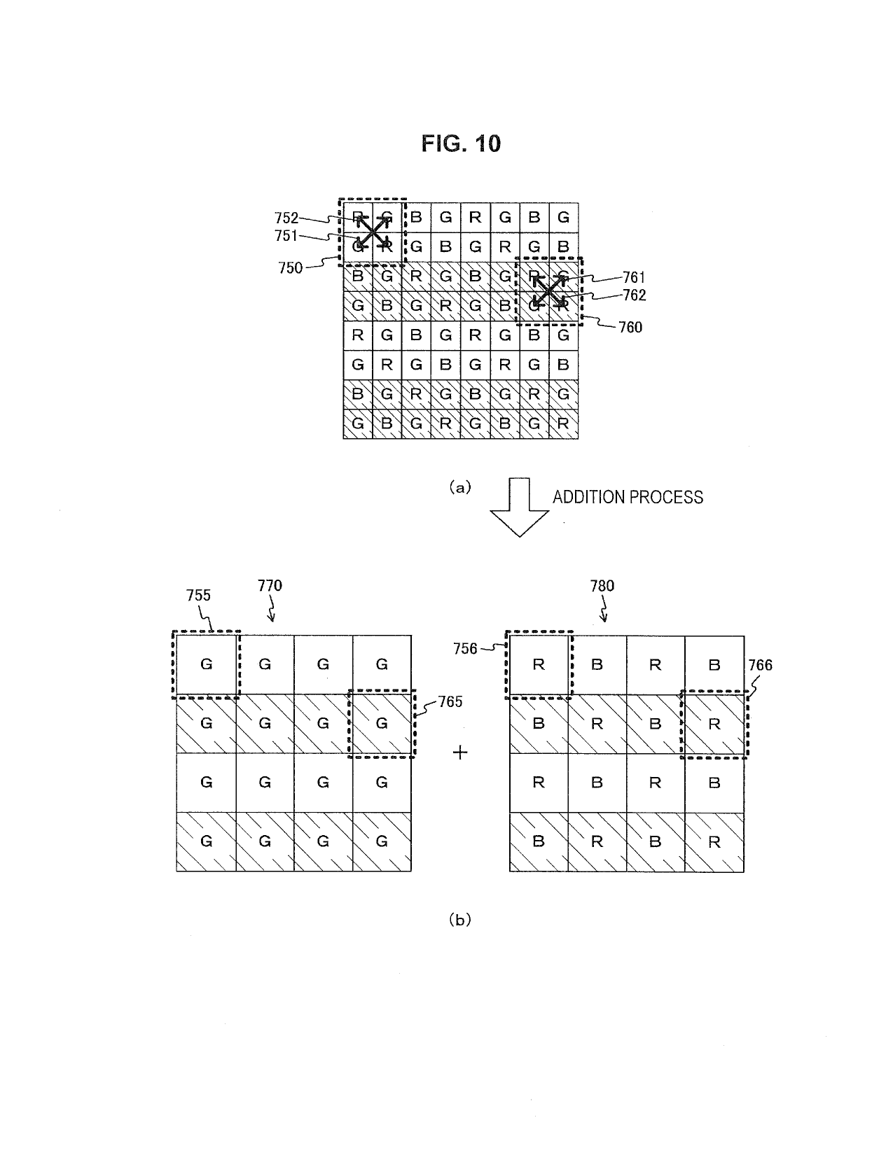

In addition, it is possible to designate an output after addition reading as an output of a pixel arrangement in which an exposure period is different for every line by performing reading in which the exposure period (long-time exposure and short-time exposure) is different for every two lines in the vertical direction. This example is illustrated in FIG. 10(b). It is possible to obtain an image of an HDR by performing image signal processing on an image signal output as described above.

In addition, because an analog addition method based on an FD is taken, in an addition operation, it is possible to improve an SNR to twice that when non-addition reading is performed. In addition, it is possible to double a reading rate even at a frame rate.

### [Timing Chart Example of Control Signals]

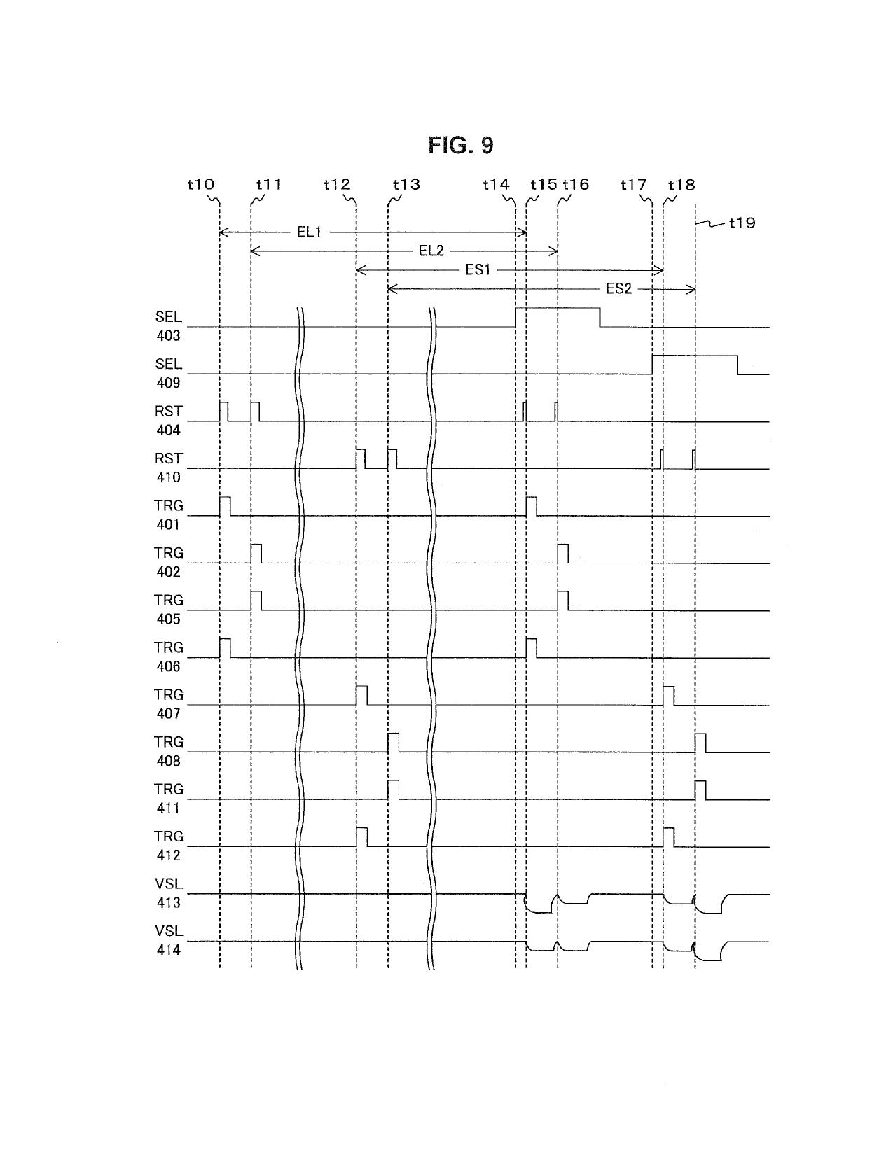

FIG. 9 is a timing chart schematically illustrating control signals for pixels constituting the image sensor 100 in accordance with the second embodiment of the present technology. In FIG. 9, the timing chart for implementing SVE addition reading in the image sensor 100 is illustrated. Because FIG. 9 is a modified example of FIG. 5, signal lines common to those of FIG. 5 are denoted by the same reference signs as in FIG. 5 and detailed description thereof is omitted.

In addition, the case in which two upper lines (pixels R1 to B8) among pixels R1 to R16 illustrated in FIG. 4 are designated as long-time-exposure pixels and two lower lines (pixels B9 to R16) are designated as short-time-exposure pixels will be described with reference to FIG. 9.

Here, although a reading method is basically the same as in the example illustrated in FIG. 5, there is a difference in that the exposure period is changed for every two lines in the vertical direction. Specifically, the pixels R1, R6, B3, and B8 constituting the two upper lines have an exposure period EL1 of long-time exposure (an exposure period from time t10 to t15). In addition, the pixels G2, G5, G4, and G7 constituting the two upper lines have an exposure period EL2 of long-time exposure (an exposure period from time t11 to t16).

In addition, the pixels B9, B14, R11, and R16 constituting the two lower lines have an exposure period ES1 of short-time exposure (an exposure period from time t12 to t18). In addition, the pixels G10, G13, G12, and G15 constituting the two lower lines have an exposure period ES2 of short-time exposure (an exposure period from time t13 to t19).

As illustrated in FIG. 9, imaging control is performed for the exposure periods EL1, EL2, ES1, and ES2, and SVE addition reading can be implemented by performing addition reading as in the first embodiment of the present technology.

### [Image Processing Example]

FIG. 10 is a diagram schematically illustrating a flow of image processing that is performed in the imaging apparatus 600 in accordance with the second embodiment of the present technology. FIG. 10 is a modified example of FIG. 7, and is different from FIG. 7 in that a long-time-exposure pixel and a short-time-exposure pixel are provided for every two lines in the vertical direction.

Here, the image processing section 620 illustrated in FIG. 6 performs an HDR synthesis process on image signals output from the long-time-exposure pixel and the short-time-exposure pixel in the image sensor 100. Thereby, the image processing section 620 can generate an HDR image.

An example of a pixel arrangement of CFs mounted on the light receiving section of the image sensor 100 is illustrated in FIG. 10(a). The pixel arrangement of FIG. 10(a) is substantially the same as the pixel arrangement illustrated in FIG. 8 or the like.

In FIG. 10(b), a configuration example of an arrangement of output data (output signals) after analog addition has been performed on pixels illustrated in FIG. 10(a) is illustrated.

In addition, a dotted rectangular frame 755 illustrated in FIG. 10(b) corresponds to output data after analog addition on two G pixels (G pixels connected by an arrow 751) within a rectangle 750 illustrated in FIG. 10(a). In addition, a dotted rectangular frame 765 illustrated in FIG. 10(b) corresponds to output data after the analog addition on two G pixels (G pixels connected by an arrow 761) within a rectangle 760 illustrated in FIG. 10(a). Because output data within the dotted rectangular frame 765 illustrated in FIG. 10(b) corresponds to short-time exposure, the inside of the dotted rectangular frame 765 is hatched with diagonal lines. In addition, other diagonal lines are also substantially the same.

In addition, a dotted rectangular frame 756 illustrated in FIG. 10(b) corresponds to output data after the analog addition on two R pixels (R pixels connected by an arrow 752) within the rectangle 750 illustrated in FIG. 10(a). In addition, a dotted rectangular frame 766 illustrated in FIG. 10(b) corresponds to output data after the analog addition on two R pixels (R pixels connected by an arrow 762) within the rectangle 760 illustrated in FIG. 10(a). Because output data within the dotted rectangular frame 766 illustrated in FIG. 10(b) corresponds to short-time exposure, the inside of the dotted rectangular frame 766 is hatched with diagonal lines. In addition, other diagonal lines are also substantially the same.

As described above, even for an image sensor in which a long-time-exposure pixel and a short-time-exposure pixel are mixed, outputs are generated so that the same centroid position as in the G, R, and B pixels within the pixel shared unit is provided. However, in the case of the R and B pixels, as illustrated in FIG. 10(b), the R and B pixels are arranged in a checkered pattern, and become output data corresponding to a long-time-exposure pixel and a short-time-exposure pixel for every line in the vertical direction.

That is, as illustrated in FIG. 10(b), image data (first image data) of G pixels is formed by an image signal after the analog addition on one pair of G pixels. For example, a first frame 770 is formed by the first image data. In addition, image data (second image data) of R pixels is formed by an image signal after the analog addition on one pair of R pixels. In addition, image data (third image data) of B pixels is formed by an image signal after the analog addition on one pair of B pixels.

For example, a second frame 780 is formed by the second image data and the third image data. In the second frame 780, for example, a line formed by image data (second image data) of R pixels and a line formed by image data (third image data) of B pixels are alternately arranged in the diagonal direction. In addition, image data of long-time-exposure pixels and image data of short-time-exposure pixels are alternately arranged in the vertical direction.

In addition, the image processing section 620 can perform image processing (for example, the HDR synthesis process) using the image data (for example, the first frame 770 and the second frame 780 illustrated in FIG. 10(b)). In addition, the control section 670 may use the data for the other processing by holding the data.

Even when the HDR synthesis process is performed as described above, the calculation process can be significantly reduced as in the first embodiment of the present technology. Thus, an image processing circuit can be significantly reduced.

As described above, it is possible to perform addition reading even during SVE in accordance with the second embodiment of the present technology.

Although an example of the imaging apparatus 600 has been described in the embodiment of the present technology, it is possible to apply the embodiment of the present technology to an electronic device (for example, a portable telephone apparatus in which an imaging section is embedded) having an imaging section with an image sensor.

In addition, although an example in which spectral sensitivities of pixels of the image sensor are three primary colors of RGB has been described in the embodiment of the present technology, a pixel having spectral sensitivity other than the three primary colors of RGB may be used. For example, it is possible to use a pixel having spectral sensitivity of a complementary color system such as yellow (Y), cyan (C), and magenta (M).

Because the above-described embodiment illustrates an example for implementing the present technology, each item described in the embodiment and an item specifying the present technology in the claims have a correspondence relationship. Likewise, the item specifying the present technology in the claims and an item to which the same name is assigned in the embodiment of the present technology have a correspondence relationship. However, the present technology is not limited to the embodiments and may be implemented by applying various modifications to the embodiments in the scope without departing from the subject matter.

Additionally, the present technology may also be configured as below.

(1) An image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal.
(2) The image sensor according to (1), wherein, by designating as a first line a line formed by pixels for generating a long-time-exposure image according to continuous exposure within a predetermined period among lines formed by the first pixel group and the second pixel group in a specific direction, and designating as a second line a line formed by pixels for generating a plurality of short-time-exposure images according to intermittent exposure within the predetermined period among the lines formed by the first pixel group and the second pixel group in the specific direction, the first line and the second line are alternately arranged in an orthogonal direction orthogonal to the specific direction.
(3) The image sensor according to (1) or (2), wherein the first pixel group and the second pixel group are pixel groups of a matrix shape in which two pixels are arranged in a specific direction and two pixels are arranged in an orthogonal direction orthogonal to the specific direction.
(4) The image sensor according to (3), wherein a position in the first pixel group of the one pair of pixels of the first spectral sensitivity constituting the first pixel group is identical to a position in the second pixel group of the one pair of pixels of the first spectral sensitivity constituting the second pixel group.
(5) The image sensor according to any one of (1) to (4), wherein, by designating a line formed by pixels of the first spectral sensitivity in a diagonal direction as a first line, designating a line formed by pixels of the second spectral sensitivity in the diagonal direction as a second line, and designating a line formed by pixels of the third spectral sensitivity in the diagonal direction as a third line, the first line is arranged alternately with the second and third lines in an orthogonal direction orthogonal to the diagonal direction.
(6) The image sensor according to any one of (1) to (5),
wherein the pixels constituting each pixel group share one floating diffusion, and
wherein pixel signals of each pair of pixels of spectral sensitivity are subjected to the analog addition by controlling exposure start and end timings for each pair of pixels of each spectral sensitivity
   (7) The image sensor according to any one of (1) to (6), wherein the pixels of the first spectral sensitivity are green (G) pixels, the pixels of the second spectral sensitivity are red (R) pixels, and the pixels of the third spectral sensitivity are blue (B) pixels.
   (8) An imaging apparatus including:
an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal; and
an image processing section configured to perform image processing using first image data formed by an image signal subjected to the analog addition on the one pair of pixels of the first spectral sensitivity, second image data formed by an image signal subjected to the analog addition on the one pair of pixels of the second spectral sensitivity, and third image data formed by an image signal subjected to the analog addition on the one pair of pixels of the third spectral sensitivity.
   (9) The imaging apparatus according to (8), wherein the image processing section performs the image processing using a first frame formed by the first image data and a second frame formed by the second image data and the third image data.
   (10) The imaging apparatus according to (9), wherein, in the second frame, a line formed by the second image data and a line formed by the third image data are alternately arranged in a diagonal direction.
   (11) An electronic device including:
an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal;
an image processing section configured to perform image processing using first image data formed by an image signal subjected to the analog addition on the one pair of pixels of the first spectral sensitivity, second image data formed by an image signal subjected to the analog addition on the one pair of pixels of the second spectral sensitivity, and third image data formed by an image signal subjected to the analog addition on the one pair of pixels of the third spectral sensitivity; and
a control section configured to control image data subjected to the image processing to be output or recorded.
   (12) An imaging method including:
performing analog addition on image signals from pixels for each pair of pixels of spectral sensitivity constituting each pixel group, and designating an analog addition result as an output signal in an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-003998 filed in the Japan Patent Office on Jan. 12, 2012, the entire content of which is hereby incorporated by reference.

What is claimed is:

1. An image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal.

2. The image sensor according to claim 1, wherein, by designating as a first line a line fowled by pixels for generating a long-time-exposure image according to continuous exposure within a predetermined period among lines formed by the first pixel group and the second pixel group in a specific direction, and designating as a second line a line formed by pixels for generating a plurality of short-time-exposure images according to intermittent exposure within the predetermined period among the lines formed by the first pixel group and the second pixel group in the specific direction, the first line and the second line are alternately arranged in an orthogonal direction orthogonal to the specific direction.

3. The image sensor according to claim 1, wherein the first pixel group and the second pixel group are pixel groups of a matrix shape in which two pixels are arranged in a specific direction and two pixels are arranged in an orthogonal direction orthogonal to the specific direction.

4. The image sensor according to claim 3, wherein a position in the first pixel group of the one pair of pixels of the first spectral sensitivity constituting the first pixel group is identical to a position in the second pixel group of the one pair of pixels of the first spectral sensitivity constituting the second pixel group.

5. The image sensor according to claim 1, wherein, by designating a line formed by pixels of the first spectral sensitivity in a diagonal direction as a first line, designating a line formed by pixels of the second spectral sensitivity in the diagonal direction as a second line, and designating a line fanned by pixels of the third spectral sensitivity in the diagonal direction as a third line, the first line is arranged alternately with the second and third lines in an orthogonal direction orthogonal to the diagonal direction.

6. The image sensor according to claim 1,
wherein the pixels constituting each pixel group share one floating diffusion, and
wherein pixel signals of each pair of pixels of spectral sensitivity are subjected to the analog addition by controlling exposure start and end timings for each pair of pixels of each spectral sensitivity.

7. The image sensor according to claim 1, wherein the pixels of the first spectral sensitivity are green (G) pixels, the pixels of the second spectral sensitivity are red (R) pixels, and the pixels of the third spectral sensitivity are blue (B) pixels.

8. An imaging apparatus comprising:
an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal; and
an image processing section configured to perform image processing using first image data formed by an image signal subjected to the analog addition on the one pair of pixels of the first spectral sensitivity, second image data formed by an image signal subjected to the analog addition on the one pair of pixels of the second spectral sensitivity, and third image data formed by an image signal subjected to the analog addition on the one pair of pixels of the third spectral sensitivity.

9. The imaging apparatus according to claim 8, wherein the image processing section performs the image processing using a first frame formed by the first image data and a second frame formed by the second image data and the third image data.

10. The imaging apparatus according to claim 9, wherein, in the second frame, a line formed by the second image data and a line formed by the third image data are alternately arranged in a diagonal direction.

11. An electronic device comprising:
an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape, and analog addition is performed on image signals from the pixels for each pair of pixels of spectral sensitivity constituting each pixel group, and an analog addition result is designated as an output signal;
an image processing section configured to perform image processing using first image data formed by an image signal subjected to the analog addition on the one pair of pixels of the first spectral sensitivity, second image data formed by an image signal subjected to the analog addition on the one pair of pixels of the second spectral sensitivity, and third image data formed by an image signal subjected to the analog addition on the one pair of pixels of the third spectral sensitivity; and
a control section configured to control image data subjected to the image processing to be output or recorded.

12. An imaging method comprising:
performing analog addition on image signals from pixels for each pair of pixels of spectral sensitivity constituting each pixel group, and designating an analog addition result as an output signal in an image sensor in which a first pixel group in which one pair of pixels of first spectral sensitivity and one pair of pixels of second spectral sensitivity are diagonally arranged and a second pixel group in which one pair of pixels of the first spectral sensitivity and one pair of pixels of third spectral sensitivity are diagonally arranged are arranged in a lattice shape.
